(19) United States
(12) Patent Application Publication
(10) Pub. No.: US 2025/0242409 A1
(43) Pub. Date: Jul. 31, 2025

(54) USE OF SACRIFICIAL SURFACE DURING DIRECTED ENERGY DEPOSITION REPAIR PROCESS

(71) Applicant: RTX Corporation, Farmington, CT (US)

(72) Inventor: Peter Breitzmann, Aldie, VA (US)

(21) Appl. No.: 18/424,314

(22) Filed: Jan. 26, 2024

(51) Int. Cl. B22F 7/06; B22F 10/28; B33Y 10/00; B33Y 80/00

(52) U.S. Cl. CPC B22F 7/062; B22F 10/28; B33Y 10/00; B33Y 80/00; B22F 2301/15; B22F 2301/205; B22F 2301/35; B22F 2998/10

(57) ABSTRACT

A method of repairing an aerospace part including inspecting the aerospace part, made from a base material, to identify a worn or defective repair region that requires repair. A sacrificial backing material, which serves as a platform for deposition of repair layers during a repair procedure, is attached to the aerospace part. A repair procedure is performed on the repair region using a directed energy deposition (DED) energy/powder head after which the sacrificial backing material is removed from the aerospace part and the aerospace part is returned to service. The repair procedure includes depositing, using the DED energy/powder head, a first layer of DED powder material in the repair region; melting and consolidating, using energy from the DED energy/powder head, the first layer of DED powder material to form a first repair layer having a pre-determined residual stress state and/or microstructure; and repeating the depositing and melting and consolidating steps to create a desired plurality of repair layers.

The present disclosure relates generally to repair of components and, more particularly, to an approach for removing a feature to enable access to a repair site.

It is often desirable to repair components used in a variety of applications, include aircraft propulsion applications, after they have suffered operations-related wear or damage due to use in the environments for which they were intended. While a variety of repair techniques are available, not all such components can be repaired using currently known techniques.

### SUMMARY

One aspect of this disclosure is directed to a method of repairing an aerospace part including inspecting the aerospace part, made from a base material, to identify a worn or defective repair region that requires repair. A sacrificial backing material, which serves as a platform for deposition of repair layers during a repair procedure, is attached to the aerospace part. A repair procedure is performed on the repair region using a directed energy deposition (DED) energy/powder head after which the sacrificial backing material is removed from the aerospace part and the aerospace part is returned to service. The repair procedure includes depositing, using the DED energy/powder head, a first layer of DED powder material in the repair region; melting and consolidating, using energy from the DED energy/powder head, the first layer of DED powder material to form a first repair layer having a pre-determined residual stress state and/or microstructure; and repeating the depositing and melting and consolidating steps to create a desired plurality of repair layers. The plurality of repair layers extend from a first section of the aerospace part to a second section of the aerospace part. Each of the plurality of repair layers has a pre-determined residual stress state and/or microstructure, which is imparted using selected levels of: DED powder material feed to the repair region; intensity of energy directed from the DED energy/powder head to the repair region; rate at which the DED energy/powder head traverses the repair region; and auxiliary heating and/or cooling provided to the repair region.

Another aspect of this disclosure is directed to a repaired aerospace part having a substrate made from a base material and a plurality of repair layers formed on the substrate using directed energy deposition (DED) techniques. The plurality of repair layers extend for a first section of the aerospace part to a second section of the aerospace part and each of the plurality of repair layers has a pre-determined residual stress state and/or microstructure.

### BRIEF DESCRIPTION OF THE DRAWINGS

FIG. 1 is a first schematic representation of an aerospace part undergoing a directed energy deposition (DED) repair process.

FIG. 2 is a flowchart of the repair process of the present disclosure.

### DETAILED DESCRIPTION

While a wide variant of repair techniques are available for aerospace components that have suffered operations-related wear or damage due to use in the environments for which they were intended, not all components can be repaired using currently known techniques. For example, repair of aerospace components, such as gas turbine engine components, using directed energy deposition (DED) techniques requires a substrate material having a certain thickness to support a DED build. Where an aerospace component that requires repair has only an insufficient amount of substrate material or is lacking a suitable substrate material at all, a sacrificial backing feature may be used to perform a repair using DED techniques.

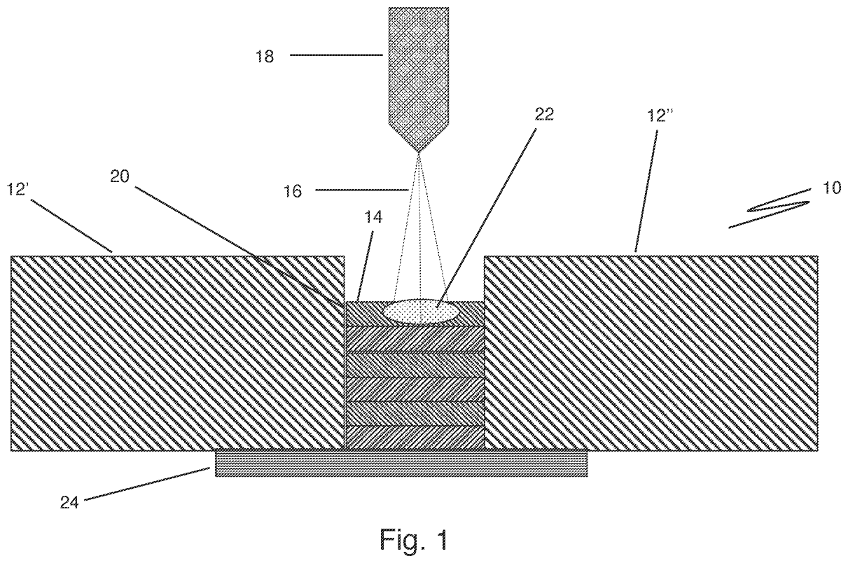

The aerospace component can lack a suitable substrate for several reasons including a desire to enable a DED repair in a through hole or the use of DED techniques to join separated features. FIG. 1 is a schematic of an aerospace part 10 that requires repair due to operational wear or damage. As shown in FIG. 1, the aerospace part 10 includes a first section 12′ separated from a second section 12″, either as a result of there being a through hole in the aerospace part 10 or because the first section 12′ is separated from the second section 12″ as a result of in-service wear or damage. For both situations, it is desired to perform a DED repair in a repair region 20 between the first section 12′ and the second section 12″. To enable the DED repair to be performed in the repair region 20 a sacrificial backing feature 24 is attached to both the first section 12′ and the second section 12″ to provide a platform or surface for building a plurality of DED repair layers 14 in the repair region 20. The sacrificial backing feature 24 can attached to both the first section 12′ and the second section 12″ using any suitable method including tack welding, brazing, or any other suitable joining method. After the desired repair is completed, the plurality of repair layers 14 extend from the first section 12′ of the aerospace part 10 to the second section 12″ of the aerospace part 10.

In performing the DED repair that is the subject of this disclosure, the structural requirements of the aerospace component 10 and the DED repair layers 14 must be considered. Carefully selecting the residual stress state and microstructure of the DED repair layers 14 in the repair region 20 can enable repairs that cannot be accomplished by other means and/or can extend the life of the repaired component after it is returned to service. Controlling the residual stress state and microstructure during a repair using DED techniques can take advantage of the layer-by-layer deposition inherent in the DED process to select a desired residual stress state and microstructure for each layer or specific area of each layer as it is deposited.

A pre-selected residual stress state and microstructure for each layer can be obtained by controlling the main parameters of the DED process, including DED powder feed rate to the repair region, the intensity of energy directed from the DED energy/powder heat to the repair region, the rate at which the DED energy/powder head traverses the repair region, and any auxiliary heating and/or cooling provided to the repair region. A person of ordinary skill will be able to establish the desired values for each of these main parameters as part of a repair development process for repairing a specific type of wear or damage to specific aerospace part. Among the considerations when establishing desired values for each of these main repairs is the specific (i.e., pre-determined) residual stress state and microstructure desired for each layer to be deposited and consolidated during the DED repair process. The pre-determined residual stress state and microstructure must account for the characteristics (e.g., composition, microstructure, etc.) of the base material from which the aerospace part is made, the characteristics of the DED powder material used for the repair (e.g., composition, microstructure after consolidation, etc.), the desired service life of the repaired aerospace part, and the operational conditions that the repaired aerospace part will experience when returned to service.

Continuing with FIG. 1, aerospace part 10 is a candidate for repair using DED techniques (e.g., using DED energy/powder head 18). DED powder material is deposited from the DED energy/powder head 18 onto the sacrificial backing feature 24 as a plurality of layers 14, initially as a layer of unconsolidated DED powder material and then as a repair layer after the DED powder material is consolidated using energy from the DED energy/powder head 18. Although not expressly denominated as such in this disclosure, the plurality of layers 14 can be described as first layer (e.g., initially a first powder layer and then a first repair layer after consolidation), a second layer (e.g., initially a second powder layer and then a second repair layer after consolidation), a third layer (e.g., initially a third powder layer and then a third repair layer after consolidation), and so on. As discussed above, the residual stress level of each repair layer 14 can be pre-determined to provide a controlled residual stress state and microstructure for the repaired aerospace part 10. Energy for performing melting and consolidating the DED powder material in each layer is provided by a laser (or electron beam gun) in the energy/powder head 18. A person of ordinary skill will know how to control the DED energy/powder head 18 to raster or scan over the DED material powder to form a melt pool 22 to accomplish the desired repair with each of the plurality of layers 14 having a pre-determined microstructure. Once the desired number of repair layers 14 have been formed in the repair region 20, the sacrificial backing feature 24 can be removed from the aerospace part 10 using any suitable method including mechanical cutting, laser cutting, mechanical grinding or mechanical machining.

The composition and amount of DED material powder and amount of energy produced by the DED energy/powder head 18 to raise the DED material powder to a temperature sufficient to form the melt pool 22 in the repair region 20 should be selected during the repair development process for a specific aerospace part 10. For example, the DED powder material may have the same composition as the base material or a different composition than the base material. In addition, the repair development process can identify whether auxiliary heating or cooling of the repair region 20 is required to achieve the pre-selected microstructure. Once the desired repair to the on aerospace part 10 is accomplished, the aerospace part 10 can be returned to service.

A person of ordinary skill will recognize that the DED energy/powder head 18 can be any combination of DED energy and powder source known in the industry. For example, the DED energy/powder head 18 can be a unitary component as shown schematically in FIG. 1 or can be separate components that provide, respectively, energy for the DED repair process and DED powder material for the DED repair process. As known, the energy source can be a laser, electron beam gun, other energy source as deemed appropriate for a particular repair.

A person of ordinary skill will recognize that the materials used for the repair to the aerospace part 10 any of the materials typically used for the applications for which the aerospace part 10 is intended. For example, if the aerospace part 10 is used in a gas turbine application, the base material used to make the aerospace part 10 can be a titanium material for cold section (e.g., compressor) applications (see Table 1 for nonlimiting examples), a superalloy material for hot section (e.g., combustor and turbine) and disk applications (See Table 2 for nonlimiting examples), or specialty steels for other applications (e.g., shafts) (See Table 3 for nonlimiting examples). A person of ordinary skill will recognize that other materials can be used as the base material for the parts and method of this disclosure.

TABLE 1
Selected Titanium Alloys

| Grade designation | Nominal chemical composition |
|---|---|
| Ti64 | Ti—6Al—4V |
| Ti811 | Ti—8Al—1Mo—1V |
| Ti1100 | Ti—6Al—2.8Sn—4Zr—0.4Mo—0.4Si |
| Ti6242 | Ti—6Al—2Sn—4Zr—2Mo |
| Ti6242S | Ti—6Al—2Sn—4Zr—2Mo—0.2Si |

TABLE 2
Selected Superalloys

| Grade designation | Nominal chemical composition |
|---|---|
| Hastelloy X | Ni22Cr1.5Co1.9Fe0.7W9Mo0.07C0.005B |
| IN 100 | 60Ni10Cr15Co3Mo4.7Ti5.5Al0.15C 0.015B0.06Zr1.0V |
| IN 625 | 58.8Ni21.5Cr9Mo5Fe3.65Ni0.5Al0.5Ti0.05C0.5Mn0.5Si0.015S0.015P |
| IN 713 | 74.2Ni12.5Cr4.2Mo2Nb0.8Ti6.1Al0.1Zr0.12C0.01B |
| IN 718 | 53Ni19Cr18.5Fe3Mo0.9Ti0.5Al5.1Cb 0.03C |
| IN 738 | 61.5Ni16Cr8.5Co1.75Mo2.6W1.75Ta0.9Nb3.4Ti3.4Al0.04Zr0.11C0.01B |
| IN 792 | 60.8Ni12.7Cr9Co2Mo3.9W3.9Ta4.2Ti3.2Al0.1Zr0.21C0.02B |
| Rene 41 | 56Ni19Cr10.5Co9.5Mo3.2Ti1.7Al0.01Zr0.08C0.005B |
| Rene 77 | 53.5Ni15Cr18.5Co5.2Mo3.5Ti4.25Al0.08C0.015B |
| Rene 80 | 60.3Ni14Cr9.5Co4Mo4W5Ti3al0.03Zr0.17C0.015B |
| Rene 80 + Hf | 59.8Ni14Cr9.5Co4Mo4W0.8Hf4.7Ti3Al0.01Zr0.15C0.015B |
| Rene88 DT | 56.4Ni16cr13Co4Mo4W0.7Nb3.7Ti 2.1Al0.03C0.015B0.03Zr |
| Rene 95 | 61Ni14Cr8Co3.5Mo3.5W3.5Nb2.5Ti3.5Al 0.16C0.01B0.05Zr |
| Rene 100 | 62.6Ni9.5Cr15Co3Mo4.2Ti5.5Al0.06Zr0.15C0.015B |
| MERL-76 | 54.4Ni12.4Cr18.6co3.3Mo1.4Nb4.3Ti5.1Al0.02C0.03B0.35Hf0.06Zr |
| Udimet 720 | 55Ni18Cr14.8Co3Mo1.25W5Ti2.5Al0.035C 0.033B0.03Zr |
| Udimet 720LI | 57Ni16Cr15Co3Mo1.25W5Ti2.5Al0.025C0.018B0.03Zr |
| MAR-M200 | 59.5Ni9Cr10Co12.5W1.8Nb2Ti5Al0.05Zr0.15C0.015B |
| MAR-M200 + Hf | Ni8Cr9Co12W2Hf1Nb1.9Ti5.0Al0.03Zr0.13C0.015B |
| MAR-M246 | 59.8Ni9Cr10Co2.5Mo10W1.5Ta1.5Ti5.5Al0.05Zr0.14C0.015B |
| MAR-M246 + Hf | Ni9Cr10Co2.5Mo10W1.5Hf1.5Ta1.5Ti5.5Al0.05Zr0.15C0.015B |
| Udimet 700 | 59Ni14.3Cr14.5Co4.3Mo3.5Ti4.3Al0.02Zr0.08C0.015B |
| Udimet 710 | 54.8Ni18Cr15Co3Mo1.5W2.5Ti5Al0.08Zr0.13C |
| Waspaloy | 58Ni19Cr13Co4Mo3Ti1.4Al |

TABLE 3
Selected Specialty Steels

| Grade designation | Nominal chemical composition |
|---|---|
| CrMoV steel | Fe1Cr0.5Ni1.25Mo0.25V0.30C |
| M152 | Fe12Cr2.5Ni1.7Mo0.3V0.12C |

While the base material used for the aerospace component 10 and material selected for the plurality of repair layers 14 is important to the properties and function of the aerospace component 10 following repair, the material used to make the sacrificial backing feature 24 is less important because the sacrificial backing feature 24 is removed before the repaired aerospace component 10 is returned to service. As such, the sacrificial backing feature 24 can be made from any material that is compatible with the DED process described above. For example, the sacrificial backing feature 24 can be made from one of the alloys listed in Tables 1-3.

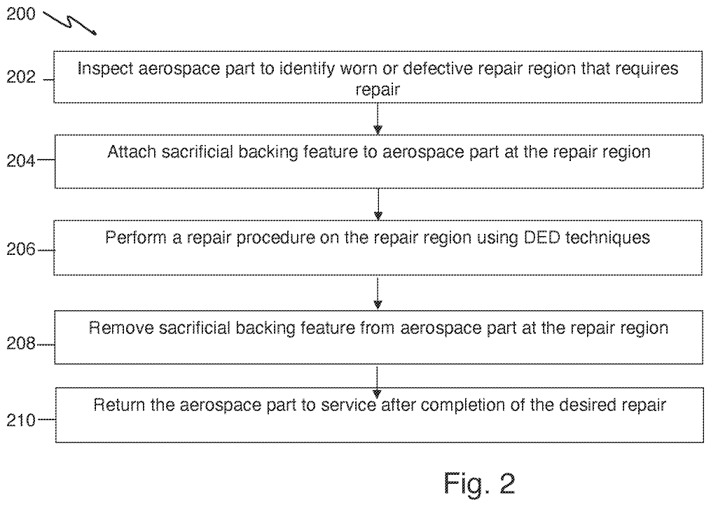

FIG. 2 is a flowchart of the overall repair procedure 200 of this disclosure. At step 202, the aerospace part 10 is inspected to identify a worn or defective repair region 20 that requires a repair. At step 204, a sacrificial backing feature 24 is attached to the aerospace part 10 to provide a platform for performing the DED repair. At step 206, a DED energy/powder head 18 deposits a plurality of layers 14 on the sacrificial backing feature 24 to accomplish the repair. As described above, each of the plurality of layers 14 can be formed with a pre-determined residual stress state and microstructure to provide the repaired aerospace part 10 with a controlled residual stress state and microstructure. At step 208, the sacrificial backing feature 24 is removed from the repaired aerospace part 10. Finally, at step 210 the aerospace part 10 is returned to service after completion of the desired repair. A person of ordinary skill will know how to perform each of these steps based upon the present disclosure and knowledge of manufacturing processes.

Using the repair technique described in this disclosure, DED techniques can be used to repair aerospace parts 10 that would not otherwise be eligible for DED repairs. The use of the sacrificial backing feature 24 permits repairs in through holes, across separate sections of the aerospace part 10, and in other situations. Controlling DED process parameters to provide a pre-determined residual stress state and/or microstructure in each layer (or specific area within each layer) can provide desired mechanical, physical, and function properties to meet desired structural and functional requirements for the repaired aerospace part. As a result, the number of available repair methods for aerospace parts 10 is expanded.

### Discussion of Possible Embodiments

The following are non-exclusive descriptions of possible embodiments of the present invention.

A method of repairing an aerospace part, which is made from a base material, includes inspecting the aerospace part to identify a worn or defective repair region that requires repair. A sacrificial backing material, which serves as a platform for deposition of repair layers during a repair procedure, is attached to the aerospace part. A repair procedure is performed on the repair region using a directed energy deposition (DED) energy/powder head. The repair procedure includes depositing, using the DED energy/powder head, a first layer of DED powder material in the repair region; melting and consolidating, using energy from the DED energy/powder head, the first layer of DED powder material to form a first repair layer having a first pre-determined residual stress state and/or microstructure; and repeating the depositing and melting and consolidating steps to create a desired plurality of repair layers. Each of the plurality of repair layers has a residual stress state and/or pre-determined microstructure. The microstructure of each of the plurality of repair layers is imparted using selected levels of DED powder material feed to the repair region, intensity of energy directed from the DED energy/powder head to the repair region, rate at which the DED energy/powder head traverses the repair region, and auxiliary heating and/or cooling provided to the repair region. After the completion of the desired repair procedure, the sacrificial backing feature is removed and the aerospace part is returned to service.

The method of the preceding paragraph can optionally include, additionally and/or alternatively, any one or more of the following features, configurations and/or additional elements:

The method of the preceding paragraph, wherein the base material comprises a titanium alloy, a superalloy material, or a specialty steel alloy.

The method of the any of the preceding paragraphs, wherein the repair procedure includes filling cracks in the repair region.

The method of the preceding paragraph, wherein the DED powder material has the same composition as the base material.

The method of the preceding paragraph, wherein the DED powder material has a different composition as the base material.

The method of the any of the preceding paragraphs, wherein the repair procedure includes reestablishing a worn surface contour in the repair region.

The method of the preceding paragraph, wherein the DED powder material has the same composition as the base material.

The method of the preceding paragraph, wherein the DED powder material has a different composition as the base material.

The method of the any of the preceding paragraphs, wherein the sacrificial backing feature is formed from a material having the same composition as the base material.

The method of the any of the preceding paragraphs, wherein the sacrificial backing feature is formed from a material having a different than the base material.

The method of the any of the preceding paragraphs, wherein the aerospace part is a component of a gas turbine engine.

A repaired aerospace part has a substrate made from a base material and a plurality of repair layers formed on the substrate using directed energy deposition (DED) techniques. The plurality of repair layers extend from a first section of the aerospace part to a second section of the aerospace part and each of the plurality of repair layers has a pre-determined residual stress state and/or microstructure.

The repaired aerospace part of the preceding paragraph can optionally include, additionally and/or alternatively, any one or more of the following features, configurations and/or additional elements:

The repaired aerospace part of the preceding paragraph, wherein the plurality of repair layers have the same composition as the base material.

The repaired aerospace part of the preceding paragraph, wherein the plurality of repair layers have a different composition than the base material.

The repaired aerospace part of the preceding paragraph, wherein the aerospace part is a component of a gas turbine engine.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of repairing an aerospace part, comprising:
inspecting the aerospace part to identify a worn or defective repair region that requires repair, wherein the aerospace part is made from a base material;
attaching a sacrificial backing material to the aerospace part, wherein the sacrificial backing material serves as a platform for deposition of repair layers during a repair procedure;
performing, using a directed energy deposition (DED) energy/powder head, the repair procedure on the repair region, wherein the repair procedure includes:
depositing, using the DED energy/powder head, a first layer of DED powder material in the repair region;
melting and consolidating, using energy from the DED energy/powder head, the first layer of DED powder material to form a first repair layer having a pre-determined residual stress state and/or microstructure;
repeating the depositing and melting and consolidating steps to create a desired plurality of repair layers, wherein the plurality of repair layers extend from a first section of the aerospace part to a second section of the aerospace part and each of the plurality of repair layers has a pre-determined residual stress state and/or microstructure; wherein the pre-determined residual stress state and/or microstructure of each of the plurality of repair layers is imparted using selected levels of:
DED powder material feed to the repair region;
intensity of energy directed from the DED energy/powder head to the repair region;
rate at which the DED energy/powder head traverses the repair region; and
auxiliary heating and/or cooling provided to the repair region;
removing the sacrificial backing plate from the aerospace part after completion of the desired repair procedure;
returning the aerospace part to service after completion of the desired repair procedure.

2. The method of claim 1, wherein the base material comprises a titanium alloy, a superalloy material, or a specialty steel alloy.

3. The method of claim 1, wherein the repair procedure includes filling a through hole in the repair region.

4. The method of claim 3, wherein the DED powder material has the same composition as the base material.

5. The method of claim 3, wherein the DED powder material has a different composition than the base material.

6. The method of claim 1, wherein the repair procedure includes joining two sections of the aerospace part at the repair region.

7. The method of claim 6, wherein the DED powder material has the same composition as the base material.

8. The method of claim 6, wherein the DED powder material has a different composition than the base material.

9. The method of claim 1, wherein the sacrificial backing feature is formed from a material having the same composition as the base material.

10. The method of claim 1, wherein the sacrificial backing feature is formed from a material having a different than the base material.

11. The method of claim 1, wherein the aerospace part is a component of a gas turbine engine.

12. A repaired aerospace part, comprising:
a substrate made from a base material; and
a plurality of repair layers formed on the substrate using directed energy deposition (DED) techniques, wherein the plurality of repair layers extend from a first section of the aerospace part to a second section of the aerospace part and each of the plurality of repair layers has a pre-determined residual stress state and/or microstructure.

13. The repaired aerospace part of claim 12, wherein the base material comprises a titanium alloy, a superalloy material, or a specialty steel alloy.

14. The repaired aerospace part of claim 12, wherein the plurality of repair layers have the same composition as the base material.

15. The repaired aerospace part of claim 12, wherein the plurality of repair layers have a different composition than the base material.

16. The repaired aerospace part of claim 12, wherein the aerospace part is a component of a gas turbine engine.
